(19) United States
(12) Patent Application Publication
(10) Pub. No.: US 2024/0242259 A1
(43) Pub. Date: Jul. 18, 2024

(54) METHOD AND DEVICE FOR INFORMATION ANALYSIS

(71) Applicant: Beijing Jingdong Zhenshi Information Technology Co., Ltd., Beijing (CN)

(72) Inventor: Shengqian JIANG, Beijing (CN)

(73) Assignee: Beijing Jingdong Zhenshi Information Technology Co., Ltd., Beijing (CN)

(21) Appl. No.: 18/011,126

(22) PCT Filed: Apr. 30, 2021
(86) PCT No.: PCT/CN2021/091270

§ 371 Date: May 8, 2023

(30) Foreign Application Priority Data
Jul. 1, 2020 (CN) 202010618819.X

(51) Int. Cl. G06Q 30/0601

(52) U.S. Cl. CPC G06Q 30/0623

(57) ABSTRACT

A method and device for information analysis are provided. The method comprises: in response to a received commodity analysis request, obtaining historical commodity information corresponding to the commodity analysis request and live broadcast information; dividing the historical commodity information according to a broadcast starting time point and a broadcast ending time point of a historical commodity to generate commodity information at different levels; analyzing the commodity information at different levels and live broadcast information corresponding to the commodity information at a corresponding level to determine various features of different levels; and according to the various features of different levels, selecting commodities in a warehouse by using a commodity and anchorman adaptive classification model to generate a list of different categories of commodities at different levels.

The present patent application is a national stage of International Application No. PCT/CN2021/091270, filed on Apr. 30, 2021, which claims priority to Chinese Patent Application No. 202010618819.X titled “METHOD AND DEVICE FOR INFORMATION ANALYSIS” filed on Jul. 1, 2020. Both of the aforementioned applications are hereby incorporated by reference in their entireties.

### TECHNICAL FIELD

Embodiments of the present application relate to the field of computer technology, more particularly, to the field of deep learning technology, and more particularly, to a method and apparatus for analyzing information.

### BACKGROUND

Online live shopping is an emerging field, and data processing technologies in other fields are difficult to be applied to this scenario due to a variety of products and a diversity of user groups. Due to a wide variety of candidate products and a high user mobility in live-selling, commodities subjectively selected by a host may vary greatly, and a large amount of time and resources are required in a selection process of the commodities. At present, a well-known host is generally made popular by an advertisement effect in the industry, and a brand effect is fed back to sale or a user-oriented recommendation system is used to increases a commodity exposure rate. However, a guidance of the host and personalized requirements of the user are not considered.

### SUMMARY

The present application provides a method and apparatus for analyzing information, a device, and a storage medium.

Some embodiments of the present application provide a method for analyzing information, the method including: in response to receiving a commodity analysis request, acquiring historical commodity information corresponding to the commodity analysis request and live-broadcast information corresponding historical commodity information, wherein the historical commodity information represents information of a historical commodity sold by a host, the live-broadcast information represents recorded information of the host during a live-broadcast process, and the historical commodity information comprises broadcast-starting time point of the historical commodity and a broadcast-ending time point of the historical commodity; dividing the historical commodity information according to the broadcast-starting time point of the historical commodity and the broadcast-ending time point of the historical commodity, to generate commodity information of each level; analyzing the commodity information of each level and the live-broadcast information corresponding to the commodity information of this level, to determine a plurality of features of each level, wherein the plurality of features comprise at least two of a host feature, a commodity feature and a user feature, and the user feature represents a feature of a user that has accessed to a live-broadcast platform of the host; and based on at least two of the host feature, the commodity feature, and the user feature of each level, selecting in-warehouse commodities by using an commodity-host adaptability classification model, to generate a commodity list of different commodity types for each level, wherein the commodity-host adaptability classification model represents a model in which commodity classification is performed based on a determination result of adaptability of a commodity and the host.

In some embodiments, dividing the historical commodity information according to the broadcast-starting time point of the historical commodity and the broadcast-ending time point of the historical commodity, to generate commodity information of each level, includes: dividing the historical commodity information according to the broadcast-starting time point of the historical commodity, the broadcast-ending time point of the historical commodity, and the live-broadcast information by using an emotion curve layering method, to generate the commodity information of each level, wherein the emotion curve layering method is used to represent a method in which dividing is performed on the commodity based on an analysis result of the highest user emotion value in the live-broadcast information.

In some embodiments, analyzing the commodity information of each level to determine the host feature of each level, includes: scoring the commodity information of each level of the host according to a weight of a commodity evaluation index and the commodity information of each level, to generate a score of each level corresponding to the commodity information of each level, and determining a comprehensive score of the host according to the score of each level; and based on a comparison result between the comprehensive score of the host and a comprehensive score of another host, tagging the host with a feature, to generated a feature tag of the host corresponding to the comparison result as the host feature of each level.

In some embodiments, analyzing the commodity information of each level to determine the commodity feature of each level, includes: determining commodity types in each level according to a commodity type selection method and the commodity information of level, and generating a commodity feature vector of each level corresponding to the commodity types of each level, wherein the commodity type selection method is used to represent a method in which a plurality of types of commodities with the highest promotion frequencies are selected; and determining a commodity similarity of each level corresponding to the feature vector of each level to be the commodity feature of each level according to the feature vector of each level and an ideal commodity model, wherein the commodity similarity represents a similarity degree between a commodity type of each level and the ideal commodity.

In some embodiments, analyzing the live-broadcast information corresponding to the commodity information of each level to determine the user feature of each level, includes: selecting user behavior information of each level corresponding to the live-broadcast information according to the live-broadcast information corresponding to the commodity information of each level, wherein the user behavior information comprises static user information and dynamic user information; and analyzing the static user information of each level and the dynamic user information of each level according to a user evaluation method, to determined a user quality feature of each level to be the user feature of each level, wherein the user evaluation method is used for performing user evaluation based on at least one of purchase history of a user, a staying duration of a user, and a consumption ability of the user.

In some embodiments, the commodity-host adaptability classification model is obtained by training using a deep learning algorithm.

In some embodiments, the method further includes: determining a target list corresponding to the commodity analysis request according to the commodity list of different commodity types of for each level; and generating a candidate-commodity scheme corresponding to the target list based on the target list.

In some embodiments, the method further includes: determining a feature tag of the host; and in response to the feature tag of the host indicating that a comprehensive score of the host is lower than an average value of comprehensive scores of other hosts, replacing commodity information with the last ranking in the target list with commodity information selected from a database, to generate an updated target list.

Some embodiments of the present application provide an apparatus for analyzing information. The apparatus includes: an acquiring unit, configured to, in response to receiving a commodity analysis request, acquire historical commodity information corresponding to the commodity analysis request and live-broadcast information corresponding to the historical commodity information, wherein the historical commodity information represents information of a historical commodity sold by a host, the live-broadcast information represents recorded information of the host during a live-broadcast process, and the historical commodity information comprises a broadcast-starting time point of the historical commodity and a broadcast-ending time point of the historical commodity; a dividing unit, configured to divide the historical commodity information according to the broadcast-starting time point of the historical commodity and the broadcast-ending time point of the historical commodity, to generate commodity information of each level; a feature determining unit, configured to analyze the commodity information of each level and the live-broadcast information corresponding to the commodity information of this level, to determine a plurality of features of each level, wherein the plurality of features comprise at least two of a host feature, a commodity feature and a user feature, and the user feature represents a feature of a user that has accessed to a live-broadcast platform of the host; and a first generating unit, configured to, based on at least two of the host feature, the commodity feature, and the user feature of each level, select in-warehouse commodities by using an commodity-host adaptability classification model, to generate a commodity list of different commodity types for each level, wherein the commodity-host adaptability classification model represents a model in which commodity classification is performed based on a determination result of adaptability of a commodity and the host.

In some embodiments, the dividing unit is further configured to divide the historical commodity information according to the broadcast-starting time point of the historical commodity, the broadcast-ending time point of the historical commodity, and the live-broadcast information by using an emotion curve layering method, to generate the commodity information of each level, wherein the emotion curve layering method is used to represent a method in which dividing is performed on the commodity based on an analysis result of the highest user emotion value in the live-broadcast information.

In some embodiments, the feature determining unit includes: a scoring module, configured to score the commodity information of each level of the host according to a weight of a commodity evaluation index and the commodity information of each level, to generate a score of each level corresponding to the commodity information of each level, and determine a comprehensive score of the host according to the score of each level; and a first determining module, configured to, based on a comparison result between the comprehensive score of the host and a comprehensive score of another host, tag the host with a feature, to generated a feature tag of the host corresponding to the comparison result as the host feature of each level.

In some embodiments, the feature determination unit includes: a first selecting module, configured to determine commodity types in each level according to a commodity type selection method and the commodity information of each level, and generate a commodity feature vector of each level corresponding to the commodity types of each level, wherein the commodity type selection method is used to represent a method in which a plurality of types of commodities with the highest promotion frequencies are selected; and a second determining module, configured to determine a commodity similarity of each level corresponding to the feature vector of each level to be the commodity feature of each level according to the feature vector of each level and an ideal commodity model, wherein the commodity similarity represents a similarity degree between a commodity type of each level and the ideal commodity.

In some embodiments, the feature determining unit includes: a second selecting module, configured to select user behavior information of each level corresponding to the live-broadcast information according to the live-broadcast information corresponding to the commodity information of each level, wherein the user behavior information comprises static user information and dynamic user information; and a third determining module, configured to analyze the static user information of each level and the dynamic user information of each level according to a user evaluation method, to determined a user quality feature of each level to be the user feature of each level, wherein the user evaluation method is used for performing user evaluation based on at least one of purchase history of a user, a staying duration of a user, and a consumption ability of the user.

In some embodiments, the commodity-host adaptability classification model in the first generating unit is obtained by training using a deep learning algorithm.

In some embodiments, the apparatus further includes: a list determining unit, configured to determine a target list corresponding to the commodity analysis request according to the commodity list of different commodity types of for each level; and a second generating unit, configured to generate a candidate-commodity scheme corresponding to the target list based on the target list.

In some embodiments, the apparatus further includes: a determining unit, configured to determine a feature tag of the host; and an updating unit, configured to, in response to the feature tag of the host indicating that a comprehensive score of the host is lower than an average value of comprehensive scores of other hosts, replace commodity information with the last ranking in the target list with commodity information selected from a database, to generate an updated target list.

Some embodiments of the present application provide an electronic device including at least one processor; and a memory in communication with the at least one processor; where the memory stores instructions executable by the at least one processor, the instructions being executed by the at least one processor to enable the at least one processor to perform the above method.

Some embodiments of the present application provide a non-transitory computer readable storage medium storing computer instructions for causing a computer to perform the above method.

It is to be understood that the description in this section is not intended to identify key or critical features of embodiments of the present application, nor is it intended to limit the scope of the present application. Other features of the present application will become readily apparent from the following description.

### BRIEF DESCRIPTION OF THE DRAWINGS

The drawings are intended to provide a better understanding of the present application and are not to be construed as limiting the application.

FIG. 1 is a schematic diagram of a first embodiment of a method for analyzing information according to the present application;

FIG. 2 is a scene diagram that may implement a method for analyzing information of an embodiment of the present application;

FIG. 3 is a schematic diagram of a second embodiment of a method for analyzing information according to the present application;

FIG. 4 is a schematic structural diagram of an embodiment of an apparatus for analyzing information according to the present application; and

FIG. 5 is a block diagram of an electronic device for implementing the method for analyzing information of an embodiment of the present application.

### DETAILED DESCRIPTION OF EMBODIMENTS

Description of exemplary embodiments of the present application are made below in connection with the accompanying drawings, in which various details of the embodiments of the present application are included to facilitate understanding, and are to be considered as exemplary only. Accordingly, one of ordinary skill in the art will recognize that various changes and modifications may be made to the embodiments described herein without departing from a scope and spirit of the present application. Also, for clarity and conciseness, descriptions of well-known functions and structures are omitted in the following description.

It should be noted that the embodiments in the present application and features in the embodiments may be combined with each other without conflict. The present application will now be described in detail with reference to the accompanying drawings and embodiments.

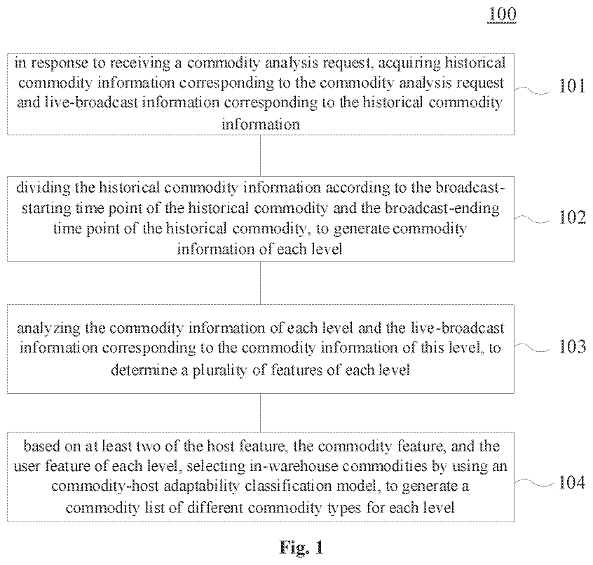

FIG. 1 shows a schematic diagram 100 of a first embodiment of a method for analyzing information according to the present application. The method for analyzing information includes the following steps 101-104.

Step 101, in response to receiving a commodity analysis request, acquiring historical commodity information corresponding to the commodity analysis request and live-broadcast information corresponding to the historical commodity information.

In the present embodiment, after an execution body receives analysis request, the historical commodity information corresponding to the commodity analysis request and the live-broadcast information corresponding to the historical commodity information may be acquired from other electronic devices through a wired connection mode or a wireless connection mode, or acquired locally. The historical commodity information may include a broadcast-starting time point of a historical commodity and an broadcast-ending time point of the historical commodity. The historical commodity information may represent information of historical commodities sold by a host, the live-broadcast information may represent recorded information of the host during a live-broadcast process, and the live-broadcast information may include user behavior information.

Step 102, dividing the historical commodity information according to the broadcast-starting time point of the historical commodity and the broadcast-ending time point of the historical commodity, to generate commodity information of each level.

In the present embodiment, the execution body may, according to a preset broadcast duration, divide the historical commodity information according to the broadcast-starting time point of the historical commodity and the broadcast-ending time point of the historical commodity, to generate the commodity information of the levels with different broadcast durations.

Step 103, analyzing the commodity information of each level and the live-broadcast information corresponding to the commodity information of this level, to determine a plurality of features of each level.

In the present embodiment, the execution body may analyze the commodity information of each level and the live-broadcast information corresponding to the commodity information of this level by using an analysis algorithm, to determine the plurality of features of each level. The plurality of features include at least two of a host feature, a commodity feature, and a user feature, the user feature being used to represent a feature of a user that has accessed to a live-broadcast platform of the host.

In some alternative implementations of the present embodiment, analyzing the commodity information of each level to determine the commodity feature of each level, includes: determining commodity types in each level according to a commodity type selection method and the commodity information of each level, and generating a commodity feature vector of each level corresponding to the commodity types of each level, the commodity type selection method being used to represent a method in which a plurality of types of commodities with the highest promotion frequencies are selected; determining a commodity similarity of each level corresponding to the feature vector of each level to be the commodity feature of each level according to the feature vector of each level and an ideal commodity model, the commodity similarity representing a similarity degree between a commodity type of each level and the ideal commodity. Determination is performed on a feature of the commodity similarity by the ideal commodity model of the host, so that the provided commodity list is closer to the ideal commodity of the host.

In some alternative implementations of the present embodiment, analyzing the commodity information of each level to determine the host feature of each level, includes: scoring the commodity information of each level of the host according to a weight of a commodity evaluation index and the commodity information of each level, to generate a score of each level corresponding to the commodity information of each level; determining a comprehensive score of the host according to the score of each level; and, based on a comparison result between the comprehensive score of the host and a comprehensive score of another host, tagging the host with a feature, to generated a feature tag of the host corresponding to the comparison result as the host feature of each level. The commodity evaluation index includes a sales volume of commodities, a number of viewers of commodities, and an exposure rate of commodities. The feature tag of the host may be 0 or 1. A feature tag 0 of the host represents that the comprehensive score of the host is lower than an average of comprehensive scores of other hosts, and the feature tag 1 of the host represents that the comprehensive score of the host is not lower than the average of the comprehensive scores of the other hosts. By determining the feature of the host, a commodity list directed to the host is generated.

In some alternative implementations of the present embodiment, analyzing the live-broadcast information corresponding to the commodity information of each level to determine the user feature of each level, includes: selecting user behavior information of each level corresponding to the live-broadcast information according to the live-broadcast information corresponding to the commodity information of each level, the user behavior information including static user information and dynamic user information; analyzing the static user information of each level and the dynamic user information of each level according to a user evaluation method, to determined a user quality feature of each level to be the user feature of each level, the user evaluation method being used for performing user evaluation based on at least one of purchase history of a user, a staying duration of a user, and a consumption ability of the user. The static user information may include information such as a user consumption level, an average user consumption cycle, a user gender, a user age, a user region, and the like. The dynamic user information may include information such as browsing, consuming, querying, commenting, tagging, and adding shopping carts of user at the platform. The user quality feature is used as the user feature for performing selecting of the commodity list, thereby improving a commodity selling effect and user watching experience from a perspective of the user.

Step 104, based on at least two of the host feature, the commodity feature, and the user feature of each level, selecting in-warehouse commodities by using an commodity-host adaptability classification model, to generate a commodity list of different commodity types for each level.

In the present embodiment, the execution body may input the in-warehouse commodities into the commodity-host adaptability classification model according to the broadcast feature, the commodity feature, and the user feature of each level, and determination on the in-warehouse perform commodities, and finally generate a commodity list of different commodity types for each level by selecting. The commodity-host adaptability classification model is used to represent performing commodity classification based on a determination result of an adaptability of a commodity to the host, and the determination result of the adaptability includes: a strong adaptability, a middle adaptability and a weak adaptability. The commodity-host adaptability classification model may be constructed based on K nearest neighbors, classification regression decision trees, naive bayes, kernel-based support vector machines, neural networks, and the like.

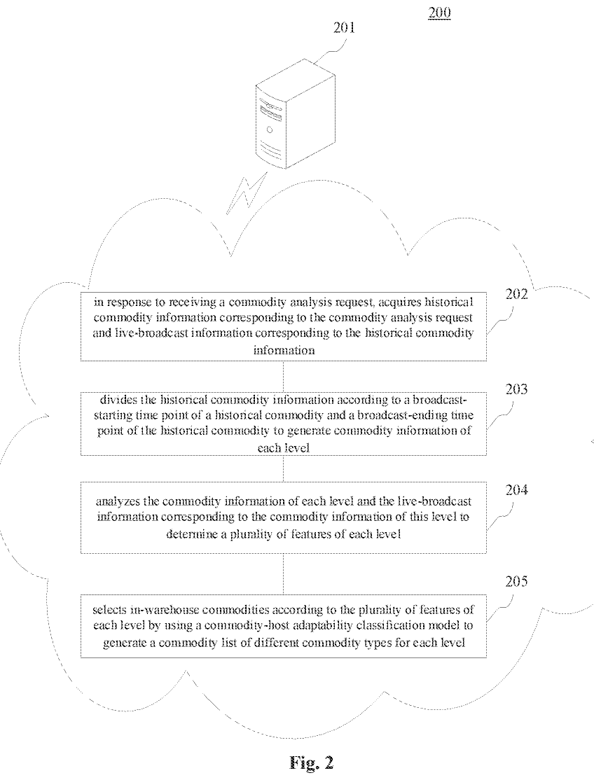

With continuing reference to FIG. 2, the method 200 for analyzing information of the present embodiment is operated in an electronic device 201. The electronic device 201 first, in response to receiving a commodity analysis request, acquires 202 historical commodity information corresponding to the commodity analysis request and live-broadcast information corresponding to the historical commodity information. Then, the electronic device 201 divides 203 the historical commodity information according to a broadcast-starting time point of a historical commodity and a broadcast-ending time point of the historical commodity to generate commodity information of each level. Then, the electronic device 201 analyzes 204 the commodity information of each level and live-broadcast information the corresponding to the commodity information of this level to determine a plurality of features of each level. Finally, the electronic device 201 selects 205 in-warehouse commodities according to the plurality of features of each level by using a commodity-host adaptability classification model to generate a commodity list of different commodity types for each level.

In the method for analyzing information provided in the above-mentioned embodiment of the present application, the historical commodity information is divided according to the broadcast-starting time point of the historical commodities and the broadcast-ending time point of the historical commodities, to generate the commodity information of each level; the commodity information of each level and the live-broadcast information corresponding to the commodity information of this level are analyzed, to determine a plurality of features of each level; and according to at least two of the host feature, the commodity feature and the user feature of each level, in-warehouse commodities are selected by using the commodity-host adaptability classification model, to generate a commodity list containing commodities of different types for each level. As such, problems in existing technologies of a great change in commodities caused by a subjective selection of the host, and a large amount of time and resources required in the process of selecting the commodities are solved. A complex problem is transformed into a multi-objective problem through hierarchical data processing, such that an analyzing process is simplified, and a system execution efficiency is improved. By taking into account the guidance of the host and the personalized needs of users, providing a highly adaptable, personalized list of commodities for live-selling hosts is achieved.

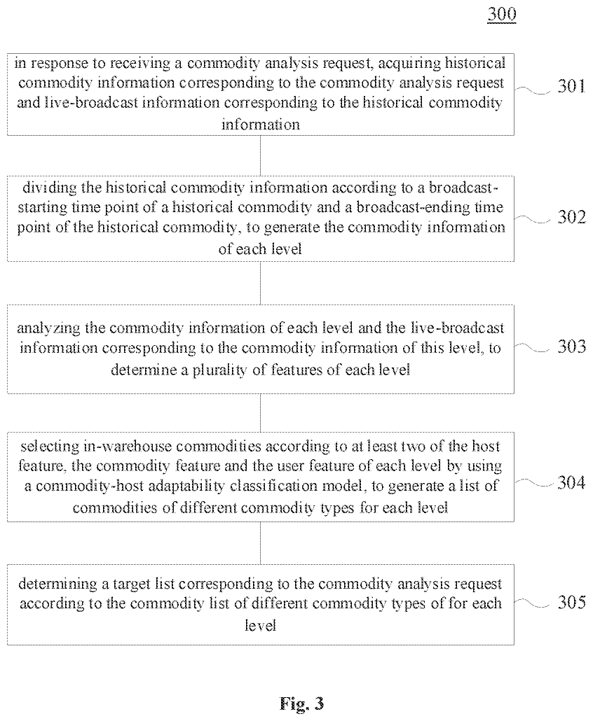

Referring further to FIG. 3, there is shown a schematic diagram 300 of a second embodiment of a method for analyzing information. The process includes the following steps 301-303.

Step 301, in response to receiving a commodity analysis request, acquiring historical commodity information corresponding to the commodity analysis request and live-broadcast information corresponding to the historical commodity information.

Step 302, dividing the historical commodity information according to a broadcast-starting time point of a historical commodity and a broadcast-ending time point of the historical commodity, to generate the commodity information of each level.

In some alternative implementations of the present embodiment, dividing the historical commodity information according to a broadcast-starting time point of a historical commodity and a broadcast-ending time point of the historical commodity, to generate the commodity information of each level, includes: dividing the historical commodity information according to the broadcast-starting time point of the historical commodity, the broadcast-ending time point of the historical commodity, and the live-broadcast information by using an emotion curve layering method, to generate the commodity information of each level, the emotion curve layering method being used to represent performing division on the commodity based on an analysis result of the highest user emotion value in the live-broadcast information. For example, an actual promotion process is divided into three stages according to a duration ratio, each stage having a duration ratio of 2:2:3, where a first-stage classification commodity is denoted as Ai (i denotes the i-th commodity of the first-stage classification), a second-stage classification commodity is denoted as Bj (j denotes the j-th commodity of the second-stage classification), and a third-stage classification commodity is denoted as Ck (k denotes the k-th commodity of the third-stage classification). If a cross-stage commodity appears, the cross-stage commodity is denoted as a lower level. By this classification method, from a perspective of a film and television work, a level division commodity information is performed more finely.

Step 303, analyzing the commodity information of each level and the live-broadcast information corresponding to the commodity information of this level, to determine a plurality of features of each level.

In some alternative implementations of the present embodiment, analyzing the commodity information of each level and the live-broadcast information corresponding to the commodity information of this level, to determine a plurality of features of each level, includes: calculating a preference degree of each commodity type according to commodity types selected for each level, to generate a user preference commodity list corresponding to the commodity types selected for each level; performing matching on each commodity type according to the user preference commodity list, to determine a Boolean quantity preference feature value corresponding to the commodity type, the Boolean quantity preference feature value being used to represent whether the user preference commodity list contains a current commodity type and a ranking of the current commodity type in the commodity types. By considering user portrait features, the commodity selling effect and the user watching experience are further improved.

In some alternative implementations of the present embodiment, analyzing the commodity information of each level and the live-broadcast information corresponding to the commodity information of this level, to determine a plurality of features of each level, includes: selecting commodity types of commodities for each level according to the historical commodity information of the host, to obtain commodity type information of the selected commodity types in each level, a price of a commodity, corresponding to commodity type information of a selected commodity type in each level, of this selected commodity type in this level, and a price of a commodity of an unselected commodity type in each level; calculating a set of feature vectors of the host according to a price of a commodity, corresponding to commodity type information of a selected commodity type in each level, of this selected commodity type in this level, and a price of a commodity of an unselected commodity type in each level; analyzing the commodity-type information of the selected commodity types in each level according to the historical commodity information of the host, to determine a user-preferred commodity type of each level and a preference weight corresponding to the user-preferred commodity type of each level; determining a commodity similarity corresponding to the set of feature vectors according to the set of feature vectors of the host and the preference weight corresponding to each user-preferred commodity type. By determining the feature of the commodity similarity, the commodity list as provided is closer to the ideal commodity information of the host.

For example, a preference weight Wₐ (the preference weight refers to a preference degree of the host for a certain type of commodities) of the certain type of commodities is represented by a promotional behavior other than live-broadcasting, and a weight range is [0, 100]. Operations such as sales and comments of the host within a given level have a corresponding extra preference weight score. Take food as an example, a preference weight of a type of food is increased by 1 for each time the host promotes this type of food during a time period of a level; each time the host issues a public message on this type of food, the preference weight is increased by 5. The preference weight affects a promotion frequency of a commodity type by the following formula, Δm=Wₐ×ξ, where Δm is a frequency increment, and ξ is a proportionality factor.

According to a live historical record of the host, after the frequency increment is accumulated, commodity types are sorted in a descending order according to the promotion frequencies, and a commodity type with the highest promotion frequency of each level are extracted. The first three commodity types in each level are extracted. For example, there are three commodity types, i.e., household necessities (2), food (4), and beauty makeup (1), where 2, 4, and 1 are rankings of the commodity types according to an overall historical record frequency of each commodity type. Household necessities are products with the highest promotion frequency at an A level, and so on. A weighted average of prices of the three commodity types of commodities and prices of other commodity types of commodities at the same level is recorded as a weighted feature price. As an ideal commodity model, a four-dimensional feature vector of an ideal commodity is λ̅=(pl₁, pl₂, pl₃, pr), in which variables are sequentially a serial number of commodity type 1, a serial number of commodity type 2, a serial number of commodity type 3, and a weighted feature price, being used as a criterion for a similarity degree.

Part of attributes of the ideal commodity will change and degrade with events (a commodity type, price change, etc.), and a degrade function will be constructed for an attribute tag herein. When an operation is performed once within the live-broadcasting platform, the weight is corrected to W_{weight}=W×e^{-z(t-ts)}, where W is a operation weight, z is a degrade rate, and t−ts is a difference between a current time and an operation time. Taking changing a commodity type as an example, during a promotional activity, a product rock-sugar aloe vera, which is sold by the host at a high frequency at level A, is changed from a food type to a beauty makeup type, an operation of type change affects an attribute of pl₂ and pr, and a weight of the unaffected attribute attribute is 1, thereby correcting part of the attributes of the ideal commodity.

The Minkowski distance is used to represent a similarity degree between a certain commodity and the ideal commodity. Taking a four-dimensional feature vector of a commodity as an example herein, the feature vector of a certain commodity is selected as λ̅′̅=(pl, pl, pl, pr) and the correction weight is used for weighting coordinates of a corresponding dimension during calculation, to obtain the similarity degree of the ideal commodity

$$d = \sqrt[4]{{\sum }_{i} {\vert {λ}_{i}^{′} - {W}_{weight , i} \times {λ}_{i} \vert}^{4}} ∘$$

Step 304, selecting in-warehouse commodities according to at least two of the host feature, the commodity feature and the user feature of each level by using a commodity-host adaptability classification model, to generate a list of commodities of different commodity types for each level.

In the present embodiment, the execution body may select the in-warehouse commodities according to the host feature, the commodity feature, and the user feature of each level by using the commodity-host adaptability classification model obtained by training, to generate a list of commodities of different commodity types for each level. The commodity-host adaptability classification model is used to represent a model in which commodities are classified based on a determination result of adaptability of a commodity and a host. The commodity-host adaptability classification model is obtained by training using a deep learning algorithm.

Step 305, determining a target list corresponding to the commodity analysis request according to the commodity list of different commodity types of for each level.

In the present embodiment, the execution body may perform selecting on commodity lists of different commodity types for the levels, and determine a final target list corresponding to the commodity analysis request based on the selected commodity information.

In some alternative implementations of the present embodiment, the method further includes: determining a feature tag of the host; and in response to the feature tag of the host indicating that a comprehensive score of the host is lower than an average value of comprehensive scores of other hosts, replacing commodity information with the last ranking in the target list with commodity information selected from a database, to generate an updated target list. For example, when it is determined that the feature tag of the host is 0 (which indicates that the comprehensive score of the host is lower than the average value of the comprehensive scores of other hosts on the platform of the host), commodities with the lowest commodity similarity is removed. Then according to a Starkelberg model, a follow-up strategy is adopted to traverse a sales-volume recommendation list of the platform, to select a commodity type of commodities with the highest adaptability to be used as key commodities and the remaining commodities are re-sorted. From a perspective of the host feature, a more suitable list of commodities is configured for the host.

In some alternative implementations of the present embodiment, the method further includes: generating a candidate-commodity scheme corresponding to the target list based on the target list. Based on the candidate-commodity scheme, a variety of accurate personalized services are provided for the host.

In the present embodiment, specific operations of the steps 301-303 is substantially identical with operations of the steps 101-103 in the embodiment shown in FIG. 1, and details are not repeated herein.

As can be seen from FIG. 3, compared with the embodiment corresponding to FIG. 1, in the schematic diagram 300 of the method for analyzing information in the present embodiment, the in-warehouse commodities are selected according to at least two of the host feature, the commodity feature and the user feature of each 1 level by using the commodity-host-adaptability-classification model obtained by training, to generate the commodity list of different commodity types for each level, and the target list corresponding to the commodity analysis request is determined according to the commodity list of different commodity types of each level. By using the deep learning technologies, a scope of applicability of the commodity-host-adaptability-classification model is wider, so that the finally obtained target list of commodities by the commodity-host-adaptability classification model is more accurate.

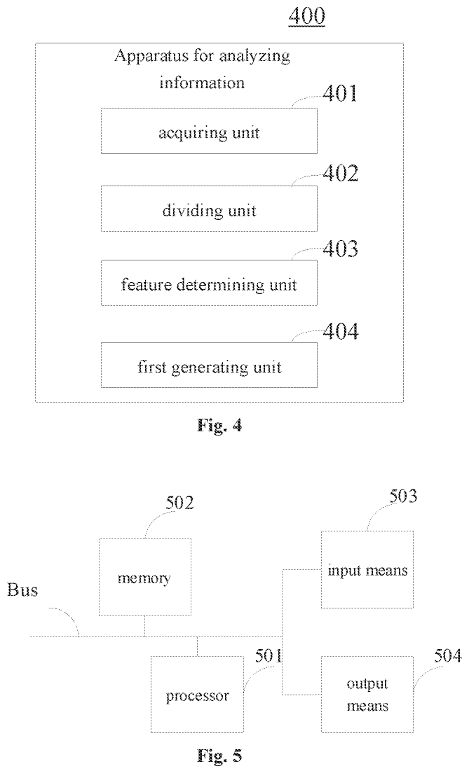

With further reference to FIG. 4, as an implementation of the method shown in each of the above figures, the present application provides an embodiment of an apparatus for analyzing information. The apparatus embodiment corresponds to the method embodiment shown in FIG. 1, and the apparatus embodiment is particularly applicable to various electronic devices.

As shown in FIG. 4, the apparatus 400 for analyzing information of the present embodiment includes: an acquiring unit 401, a dividing unit 402, a feature determining unit 403, and a first generating unit 404. The acquiring unit, configured to, in response to receiving a commodity analysis request, acquire historical commodity information corresponding to the commodity analysis request and live-broadcast information corresponding to the historical commodity information, wherein the historical commodity information represents information of a historical commodity sold by a host, the live-broadcast information represents recorded information of the host during a live-broadcast process, and the historical commodity information comprises a broadcast-starting time point of the historical commodity and a broadcast-ending time point of the historical commodity; the dividing unit, configured to divide the historical commodity information according to the broadcast-starting time point of the historical commodity and the broadcast-ending time point of the historical commodity, to generate commodity information of each level; the feature determining unit, configured to analyze the commodity information of each level and the live-broadcast information corresponding to the commodity information of this level, to determine a plurality of features of each level, wherein the plurality of features comprise at least two of a host feature, a commodity feature and a user feature, and the user feature represents a feature of a user that has accessed to a live-broadcast platform of the host; and the first generating unit, configured to, based on at least two of the host feature, the commodity feature, and the user feature of each level, select in-warehouse commodities by using an commodity-host adaptability classification model, to generate a commodity list of different commodity types for each level, wherein the commodity-host adaptability classification model represents a model in which commodity classification is performed based on a determination result of adaptability of a commodity and the host.

In the present embodiment, the specific processing and the technical effects of the acquiring unit 401, the dividing unit 402, the feature determining unit 403, and the first generating unit 404 of the apparatus 400 for analyzing the information, may be described with reference to the step 101 to step 104 in the corresponding embodiment of FIG. 1, respectively, and details are not repeated herein.

In some alternative implementations of the present embodiment, the dividing unit is further configured to the historical commodity information according to the broadcast-starting time point of the historical commodity, the broadcast-ending time point of the historical commodity, and the live-broadcast information by using an emotion curve layering method, to generate the commodity information of each level, wherein the emotion curve layering method is used to represent a method in which dividing is performed on the commodity based on an analysis result of the highest user emotion value in the live-broadcast information.

In some alternative implementations of the present embodiment, the feature determining unit includes: a scoring module, configured to score the commodity information of each level of the host according to a weight of a commodity evaluation index and the commodity information of each level, to generate a score of each level corresponding to the commodity information of each level, and determine a comprehensive score of the host according to the score of each level; and a first determining module, configured to, based on a comparison result between the comprehensive score of the host and a comprehensive score of another host, tag the host with a feature, to generated a feature tag of the host corresponding to the comparison result as the host feature of each level.

In some alternative implementations of the present embodiment, the feature determining unit includes: a first selecting module, configured to determine commodity types in each level according to a commodity type selection method and the commodity information of each level, and generate a commodity feature vector of each level corresponding to the commodity types of each level, wherein the commodity type selection method is used to represent a method in which a plurality of types of commodities with the highest promotion frequencies are selected; and a second determining module, configured to determine a commodity similarity of each level corresponding to the feature vector of each level to be the commodity feature of each level according to the feature vector of each level and an ideal commodity model, wherein the commodity similarity represents a similarity degree between a commodity type of each level and the ideal commodity.

In some alternative implementations of the present embodiment, the feature determining unit includes: a second selecting module, configured to select user behavior information of each level corresponding to the live-broadcast information according to the live-broadcast information corresponding to the commodity information of each level, wherein the user behavior information comprises static user information and dynamic user information; and a third determining module, configured to analyze the static user information of each level and the dynamic user information of each level according to a user evaluation method, to determined a user quality feature of each level to be the user feature of each level, wherein the user evaluation method is used for performing user evaluation based on at least one of purchase history of a user, a staying duration of a user, and a consumption ability of the user.

In some alternative implementations of the present embodiment, the commodity-host adaptability classification model in the first generating unit is obtained by training using a deep learning algorithm.

In some alternative implementations of the present embodiment, the apparatus further includes: a list determining unit, configured to determine a target list corresponding to the commodity analysis request according to the commodity list of different commodity types of for each level; and a second generating unit, configured to generate a candidate-commodity scheme corresponding to the target list based on the target list.

In some alternative implementations of the present embodiment, the apparatus further includes: a determining unit, configured to determine a feature tag of the host; and an updating unit, configured to, in response to the feature tag of the host indicating that a comprehensive score of the host is lower than an average value of comprehensive scores of other hosts, replace commodity information with the last ranking in the target list with commodity information selected from a database, to generate an updated target list.

According to an embodiment of the present disclosure, the present disclosure also provides an electronic device and a readable storage medium.

FIG. 5 is a block diagram of an electronic device for analyzing information according to an embodiment of the present application. Electronic devices are intended to represent various forms of digital computers, such as laptop computers, desktop computers, worktables, personal digital assistants, servers, blade servers, mainframe computers, and other suitable computers. Electronic devices may also represent various forms of mobile devices, such as personal digital processing, cellular telephones, smart phones, wearable devices, and other similar computing devices. The components shown herein, their connections and relationships, and their functions are by way of example only and are not intended to limit the implementation of the present application as described and/or claimed herein.

As shown in FIG. 5, the electronic device includes one or more processors 501, a memory 502, and an interface for connecting components, including a high speed interface and a low speed interface. The various components are interconnected by different buses and may be mounted on a common motherboard or otherwise mounted as desired. The processor may process instructions executed within the electronic device, including instructions stored in or on a memory to display graphical information of the GUI on an external input/output device, such as a display device coupled to an interface. In other embodiments, multiple processors and/or multiple buses may be used with multiple processors and multiple memories, if desired. Similarly, a plurality of electronic devices may be connected, each providing a portion of the necessary operations (e.g., as a server array, a set of blade servers, or a multiprocessor system). A processor 501 is exemplified in FIG. 5.

The memory 502 is a non-instantaneous computer readable storage medium provided herein. The memory stores instructions executable by the at least one processor to cause the at least one processor to perform the method for analyzing information provided herein. The non-instantaneous computer readable storage medium of the present application stores computer instructions for causing a computer to perform the method for analyzing information provided herein.

The memory 502, as a non-instantaneous computer readable storage medium, can be used to store non-instantaneous software programs, non-instantaneous computer executable programs, and modules, such as program instructions/modules corresponding to the method for analyzing information in the embodiments of the present application (e.g., the acquiring unit 401, the dividing unit 402, the feature determining unit 403, and the first generating unit 404 shown in FIG. 4). The processor 501 executes various functional applications and data processing of the server by running non-instantaneous software programs, instructions, and modules stored in the memory 502, that is, implementing the method for analyzing information in the above-described method embodiment.

The memory 502 may include a storage program area and a storage data area, the storage program area may store an operating system, an application program required for at least one function, the storage data area may store data or the like created according to the use of the electronic device for analyzing the information. In addition, memory 502 may include high speed random access memory, and may also include non-instantaneous memory, such as at least one magnetic disk storage device, flash memory device, or other non-instantaneous solid state storage device. In some embodiments, memory 502 may optionally include remotely disposed memory relative to processor 501, the remotely disposed memory may be connected via a network to an electronic device for analyzing the information. Examples of such networks include, but are not limited to, the Internet, enterprise intranets, local area networks, mobile communication networks, and combinations thereof.

The electronic device for analyzing the information may further include input means 503 and output means 504. The processor 501, the memory 502, the input means 503 and the output means 504 may be connected via a bus or otherwise, as illustrated in FIG. 5.

The input means 503 may receive input number or character information, and generate key signal input related to user settings and functional control of an electronic device for analyzing the information, such as a touch screen, a keypad, a mouse, a track pad, a touch pad, a pointer bar, one or more mouse buttons, a trackball, a joystick, or the like. The output device 504 may include a display device, an auxiliary lighting device (e.g., an LED), a tactile feedback device (e.g., a vibration motor), and the like. The display device may include, but is not limited to, a liquid crystal display (LCD), a light emitting diode (LED) display, and a plasma display. In some embodiments, the display device may be a touch screen.

The various embodiments of the systems and techniques described herein may be implemented in digital electronic circuit systems, integrated circuit systems, application specific ASICs (application specific integrated circuits), computer hardware, firmware, software, and/or combinations thereof. These various embodiments may include: being implemented in one or more computer programs that may execute and/or interpret on a programmable system including at least one programmable processor, the programmable processor may be a dedicated or general purpose programmable processor, may receive data and instructions from a memory system, at least one input means, and at least one output means, and transmit the data and instructions to the memory system, the at least one input means, and the at least one output means.

These computing programs (also referred to as programs, software, software applications, or code) include machine instructions of a programmable processor and may be implemented in high-level procedures and/or object-oriented programming languages, and/or assembly/machine languages. As used herein, the terms “machine readable medium” and “computer readable medium” refer to any computer program product, device, and/or device (e.g., magnetic disk, optical disk, memory, programmable logic device (PLD)) for providing machine instructions and/or data to a programmable processor, including: a machine readable medium that receives machine instructions as machine readable signals. The term “machine readable signal” refers to any signal used to provide machine instructions and/or data to a programmable processor.

To provide interaction with a user, the systems and techniques described herein may be implemented on a computer, the computer have a display device (e.g., a CRT (cathode ray tube) or LCD (liquid crystal display) monitor) for displaying information to the user; and a keyboard and a pointing device (e.g., a mouse or a trackball) through which a user can provide input to a computer. Other types of devices may also be used to provide interaction with a user; For example, the feedback provided to the user may be any form of sensory feedback (e.g., visual feedback, auditory feedback, or tactile feedback); and the input from the user may be received in any form, including acoustic input, speech input, or tactile input.

The systems and techniques described herein may be implemented in a computing system including a background component (e.g., as a data server), or a computing system including a middleware component (e.g., an application server), or computing system including a front-end component (e.g., a user computer having a graphical user interface or a web browser through which a user may interact with embodiments of the systems and techniques described herein), or a computing system including any combination of such background component, middleware component, or front-end component. The components of the system may be interconnected by any form or medium of digital data communication (e.g., a communication network). Examples of communication networks include a local area network (LAN), a wide area network (WAN), and the Internet.

The computer system may include a client and a server. The client and server are typically remote from each other and typically interact through a communication network. The relationship between the client and the server is generated by a computer program running on the corresponding computer and having a client-server relationship with each other.

According to the technical solution of the embodiment of the present application, the historical commodity information is divided according to the broadcast-starting time point of the historical commodities and the broadcast-ending time point of the historical commodities, to generate the commodity information of each level; the commodity information of each level and the live-broadcast information corresponding to the commodity information of this level are analyzed, to determine a plurality of features of each level; and according to at least two of the host feature, the commodity feature and the user feature of each level, in-warehouse commodities are selected by using the commodity-host adaptability classification model, to generate a commodity list containing commodities of different types for each level. As such, problems in existing technologies of a great change in commodities caused by a subjective selection of the host, and a large amount of time and resources required in the process of selecting the commodities are solved. A complex problem is transformed into a multi-objective problem through hierarchical data processing, such that an analyzing process is simplified, and a system execution efficiency is improved. By taking into account the guidance of the host and the personalized needs of users, providing a highly adaptable, personalized list of commodities for live-selling hosts is achieved. The in-warehouse commodities are selected according to at least two of the host feature, the commodity feature and the user feature of each level by using the commodity-host-adaptability-classification model obtained by training, to generate the commodity list of different commodity types for each level, and the target list corresponding to the commodity analysis request is determined according to the commodity list of different commodity types of each level. By using the deep learning technologies, a scope of applicability of the commodity-host-adaptability-classification model is wider, so that the finally obtained target list of commodities by the commodity-host-adaptability classification model is more accurate.

It is to be understood that the steps of reordering, adding or deleting may be performed using the various forms shown above. For example, the steps described in the present application may be performed in parallel or sequentially or in a different order, so long as the desired results of the technical solution disclosed in the present application can be realized, and no limitation is imposed herein.

The foregoing detailed description is not intended to limit the scope of the present application. It will be appreciated by those skilled in the art that various modifications, combinations, subcombinations, and substitutions may be made depending on design requirements and other factors. Any modifications, equivalents, and modifications that fall within the spirit and principles of this application are intended to be included within the scope of this application.

1. A method for analyzing information, the method comprises:
in response to receiving a commodity analysis request, acquiring historical commodity information corresponding to the commodity analysis request and live-broadcast information corresponding to the historical commodity information, wherein the historical commodity information represents information of a historical commodity sold by a host, the live-broadcast information represents recorded information of the host during a live-broadcast process, and the historical commodity information comprises a broadcast-starting time point of the historical commodity and a broadcast-ending time point of the historical commodity;
dividing the historical commodity information according to the broadcast-starting time point of the historical commodity and the broadcast-ending time point of the historical commodity, to generate commodity information of each level;
analyzing the commodity information of each level and the live-broadcast information corresponding to the commodity information of this level, to determine a plurality of features of each level, wherein the plurality of features comprise at least two of a host feature, a commodity feature and a user feature, and the user feature represents a feature of a user that has accessed to a live-broadcast platform of the host; and
based on at least two of the host feature, the commodity feature, and the user feature of each level, selecting in-warehouse commodities by using an commodity-host adaptability classification model, to generate a commodity list of different commodity types for each level, wherein the commodity-host adaptability classification model represents a model in which commodity classification is performed based on a determination result of adaptability of a commodity and the host.

2. The method according to claim 1, wherein dividing the historical commodity information according to the broadcast-starting time point of the historical commodity and the broadcast-ending time point of the historical commodity, to generate commodity information of each level, comprises:
dividing the historical commodity information according to the broadcast-starting time point of the historical commodity, the broadcast-ending time point of the historical commodity, and the live-broadcast information by using an emotion curve layering method, to generate the commodity information of each level, wherein the emotion curve layering method is used to represent a method in which dividing is performed on the commodity based on an analysis result of the highest user emotion value in the live-broadcast information.

3. The method according to claim 1, wherein analyzing the commodity information of each level to determine the host feature of each level, comprises:
scoring the commodity information of each level of the host according to a weight of a commodity evaluation index and the commodity information of each level, to generate a score of each level corresponding to the commodity information of each level, and determining a comprehensive score of the host according to the score of each level; and
based on a comparison result between the comprehensive score of the host and a comprehensive score of another host, tagging the host with a feature, to generated a feature tag of the host corresponding to the comparison result as the host feature of each level.

4. The method according to claim 1, wherein analyzing the commodity information of each level to determine the commodity feature of each level, comprises:
determining commodity types in each level according to a commodity type selection method and the commodity information of each level, and generating a commodity feature vector of each level corresponding to the commodity types of each level, wherein the commodity type selection method is used to represent a method in which a plurality of types of commodities with the highest promotion frequencies are selected; and
determining a commodity similarity of each level corresponding to the feature vector of each level to be the commodity feature of each level according to the feature vector of each level and an ideal commodity model, wherein the commodity similarity represents a similarity degree between a commodity type of each level and the ideal commodity.

5. The method according to claim 1, wherein analyzing the live-broadcast information corresponding to the commodity information of each level to determine the user feature of each level, comprises:
selecting user behavior information of each level corresponding to the live-broadcast information according to the live-broadcast information corresponding to the commodity information of each level, wherein the user behavior information comprises static user information and dynamic user information; and
analyzing the static user information of each level and the dynamic user information of each level according to a user evaluation method, to determined a user quality feature of each level to be the user feature of each level, wherein the user evaluation method is used for performing user evaluation based on at least one of purchase history of a user, a staying duration of a user, and a consumption ability of the user.

6. The method according to claim 1, wherein the commodity-host adaptability classification model is obtained by training using a deep learning algorithm.

7. The method according to claim 1, further comprising:
determining a target list corresponding to the commodity analysis request according to the commodity list of different commodity types of for each level; and
generating a candidate-commodity scheme corresponding to the target list based on the target list.

8. The method according to claim 1, further comprising:
determining a feature tag of the host; and
in response to the feature tag of the host indicating that a comprehensive score of the host is lower than an average value of comprehensive scores of other hosts, replacing commodity information with the last ranking in the target list with commodity information selected from a database, to generate an updated target list.

9. An apparatus for analyzing information, the apparatus comprising:
at least one processor; and
a memory storing instructions, wherein the instructions when executed by the at least one processor, cause the at least one processor to perform operations, the operations comprising:
in response to receiving a commodity analysis request, acquiring historical commodity information corresponding to the commodity analysis request and live-broadcast information corresponding to the historical commodity information, wherein the historical commodity information represents information of a historical commodity sold by a host, the live-broadcast information represents recorded information of the host during a live-broadcast process, and the historical commodity information comprises a broadcast-starting time point of the historical commodity and a broadcast-ending time point of the historical commodity;
dividing the historical commodity information according to the broadcast-starting time point of the historical commodity and the broadcast-ending time point of the historical commodity, to generate commodity information of each level;
analyzing the commodity information of each level and the live-broadcast information corresponding to the commodity information of this level, to determine a plurality of features of each level, wherein the plurality of features comprise at least two of a host feature, a commodity feature and a user feature, and the user feature represents a feature of a user that has accessed to a live-broadcast platform of the host; and
based on at least two of the host feature, the commodity feature, and the user feature of each level, selecting in-warehouse commodities by using an commodity-host adaptability classification model, to generate a commodity list of different commodity types for each level, wherein the commodity-host adaptability classification model represents a model in which commodity classification is performed based on a determination result of adaptability of a commodity and the host.

10. The apparatus according to claim 9, wherein dividing the historical commodity information according to the broadcast-starting time point of the historical commodity and the broadcast-ending time point of the historical commodity, to generate commodity information of each level, comprises: dividing the historical commodity information according to the broadcast-starting time point of the historical commodity, the broadcast-ending time point of the historical commodity, and the live-broadcast information by using an emotion curve layering method, to generate the commodity information of each level, wherein the emotion curve layering method is used to represent a method in which dividing is performed on the commodity based on an analysis result of the highest user emotion value in the live-broadcast information.

11. The apparatus according to claim 9, wherein analyzing the commodity information of each level to determine the host feature of each level, comprises:
scoring the commodity information of each level of the host according to a weight of a commodity evaluation index and the commodity information of each level, to generate a score of each level corresponding to the commodity information of each level, and determining a comprehensive score of the host according to the score of each level; and
based on a comparison result between the comprehensive score of the host and a comprehensive score of another host, tag-tagging the host with a feature, to generated a feature tag of the host corresponding to the comparison result as the host feature of each level.

12. The apparatus according to claim 9, wherein analyzing the commodity information of each level to determine the commodity feature of each level, comprises:
determining commodity types in each level according to a commodity type selection method and the commodity information of each level, and generate-generating a commodity feature vector of each level corresponding to the commodity types of each level, wherein the commodity type selection method is used to represent a method in which a plurality of types of commodities with the highest promotion frequencies are selected; and
determining a commodity similarity of each level corresponding to the feature vector of each level to be the commodity feature of each level according to the feature vector of each level and an ideal commodity model, wherein the commodity similarity represents a similarity degree between a commodity type of each level and the ideal commodity.

13. The apparatus according to claim 9, wherein analyzing the live-broadcast information corresponding to the commodity information of each level to determine the user feature of each level, comprises:
selecting user behavior information of each level corresponding to the live-broadcast information according to the live-broadcast information corresponding to the commodity information of each level, wherein the user behavior information comprises static user information and dynamic user information; and
analyzing the static user information of each level and the dynamic user information of each level according to a user evaluation method, to determined a user quality feature of each level to be the user feature of each level, wherein the user evaluation method is used for performing user evaluation based on at least one of purchase history of a user, a staying duration of a user, and a consumption ability of the user.

14. The apparatus according to claim 9, wherein the commodity-host adaptability classification model in the first generating unit is obtained by training using a deep learning algorithm.

15. The apparatus according to claim 9, the operations further comprising:
determining a target list corresponding to the commodity analysis request according to the commodity list of different commodity types of for each level; and
generating a candidate-commodity scheme corresponding to the target list based on the target list.

16. The apparatus according to claim 9, the operations further comprising:
determining a feature tag of the host; and
in response to the feature tag of the host indicating that a comprehensive score of the host is lower than an average value of comprehensive scores of other hosts, replacing commodity information with the last ranking in the target list with commodity information selected from a database, to generate an updated target list.

17. (canceled)

18. A non-transitory computer readable storage medium storing computer instructions, wherein, the computer instructions are used to cause the computer to perform operations comprising:
in response to receiving a commodity analysis request, acquiring historical commodity information corresponding to the commodity analysis request and live-broadcast information corresponding to the historical commodity information, wherein the historical commodity information represents information of a historical commodity sold by a host, the live-broadcast information represents recorded information of the host during a live-broadcast process, and the historical commodity information comprises a broadcast-starting time point of the historical commodity and a broadcast-ending time point of the historical commodity;
dividing the historical commodity information according to the broadcast-starting time point of the historical commodity and the broadcast-ending time point of the historical commodity, to generate commodity information of each level;
analyzing the commodity information of each level and the live-broadcast information corresponding to the commodity information of this level, to determine a plurality of features of each level, wherein the plurality of features comprise at least two of a host feature, a commodity feature and a user feature, and the user feature represents a feature of a user that has accessed to a live-broadcast platform of the host; and
based on at least two of the host feature, the commodity feature, and the user feature of each level, selecting in-warehouse commodities by using an commodity-host adaptability classification model, to generate a commodity list of different commodity types for each level, wherein the commodity-host adaptability classification model represents a model in which commodity classification is performed based on a determination result of adaptability of a commodity and the host.

19. The non-transitory computer readable medium of claim 18, wherein dividing the historical commodity information according to the broadcast-starting time point of the historical commodity and the broadcast-ending time point of the historical commodity, to generate commodity information of each level, comprises:
dividing the historical commodity information according to the broadcast-starting time point of the historical commodity, the broadcast-ending time point of the historical commodity, and the live-broadcast information by using an emotion curve layering method, to generate the commodity information of each level, wherein the emotion curve layering method is used to represent a method in which dividing is performed on the commodity based on an analysis result of the highest user emotion value in the live-broadcast information.

20. The non-transitory computer readable medium of claim 18, wherein analyzing the commodity information of each level to determine the host feature of each level, comprises:
scoring the commodity information of each level of the host according to a weight of a commodity evaluation index and the commodity information of each level, to generate a score of each level corresponding to the commodity information of each level, and determining a comprehensive score of the host according to the score of each level; and
based on a comparison result between the comprehensive score of the host and a comprehensive score of another host, tagging the host with a feature, to generated a feature tag of the host corresponding to the comparison result as the host feature of each level.

21. The non-transitory computer readable medium of claim 18, wherein analyzing the commodity information of each level to determine the commodity feature of each level, comprises:
determining commodity types in each level according to a commodity type selection method and the commodity information of each level, and generating a commodity feature vector of each level corresponding to the commodity types of each level, wherein the commodity type selection method is used to represent a method in which a plurality of types of commodities with the highest promotion frequencies are selected; and
determining a commodity similarity of each level corresponding to the feature vector of each level to be the commodity feature of each level according to the feature vector of each level and an ideal commodity model, wherein the commodity similarity represents a similarity degree between a commodity type of each level and the ideal commodity.
